(19) United States
(12) Patent Application Publication
(10) Pub. No.: US 2012/0050302 A1
(43) Pub. Date: Mar. 1, 2012

(54) METHOD AND APPARATUS FOR ENHANCING A WHITE-BOARD

(75) Inventors: Goksel Dedeoglu, Plano, TX (US); Andrew Miller, Sanford, FL (US); Marshall Capps, Farmers Branch, TX (US)

(73) Assignee: TEXAS INSTRUMENTS INCORPORATED, Dallas, TX (US)

(21) Appl. No.: 13/222,279

(22) Filed: Aug. 31, 2011

Related U.S. Application Data
(60) Provisional application No. 61/378,649, filed on Aug. 31, 2010.

(51) Int. Cl. G09G 5/00

(52) U.S. Cl. 345/581

(57) ABSTRACT

A method and apparatus for projecting enhanced information on a white-board. The method includes capturing an image of information on a white-board, analyzing the captured image and determining the type of enhancement needed for the information displayed, enhancing the information in the image according to the determined type of enhancement, and projecting the enhanced information on the white-board.

### CROSS-REFERENCE TO RELATED APPLICATIONS

This application claims benefit of United States provisional patent application Ser. No. 61/378,649, filed Aug. 31, 2010, which is herein incorporated by reference.

### BACKGROUND OF THE INVENTION

1. Field of the Invention

Embodiments of the present invention generally relate to a method and apparatus for enhancing a white-board experience.

2. Description of the Related Art

The typical shortcomings of a white-board projector pair as found in classrooms and meeting spaces include markers that are running out of ink and become difficult to read, and graphics/drawings that are impractical to color in or texture with conventional markers and the likes.

Therefore, there is a need for a method and/or apparatus for improving a white-board and experience of a white-board.

### SUMMARY OF THE INVENTION

Embodiments of the present invention relate to a method and apparatus for projecting enhanced information on a white-board. The method includes capturing an image of information displayed on a white-board, analyzing the captured image and determining the type of enhancement needed for the information displayed, enhancing the information in the image according to the determined type of enhancement, and projecting the enhanced information on the white-board.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an embodiment of a white-board projector pair augmented with an image capturing device and a processor;

FIG. 2 is an embodiment of a demonstration of utilizing an enhanced white-board system in a low-ink and low-contrast whiteboard content;

FIG. 3 is an embodiment of a projector casting a dark image except on pixels where there is writing for increasing contrast;

FIG. 4 is an embodiment of an enhanced white-board system utilized to complete drawings, fill within shapes, and color or thicken;

FIG. 5 is an embodiment of a block diagram of an enhanced white-board system;

FIG. 6 is an embodiment of a flow diagram for a method for operating an enhanced white-board system; and

FIG. 7 is an embodiment of a flow diagram method for a method for calibrating an enhanced white-board system.

### DETAILED DESCRIPTION

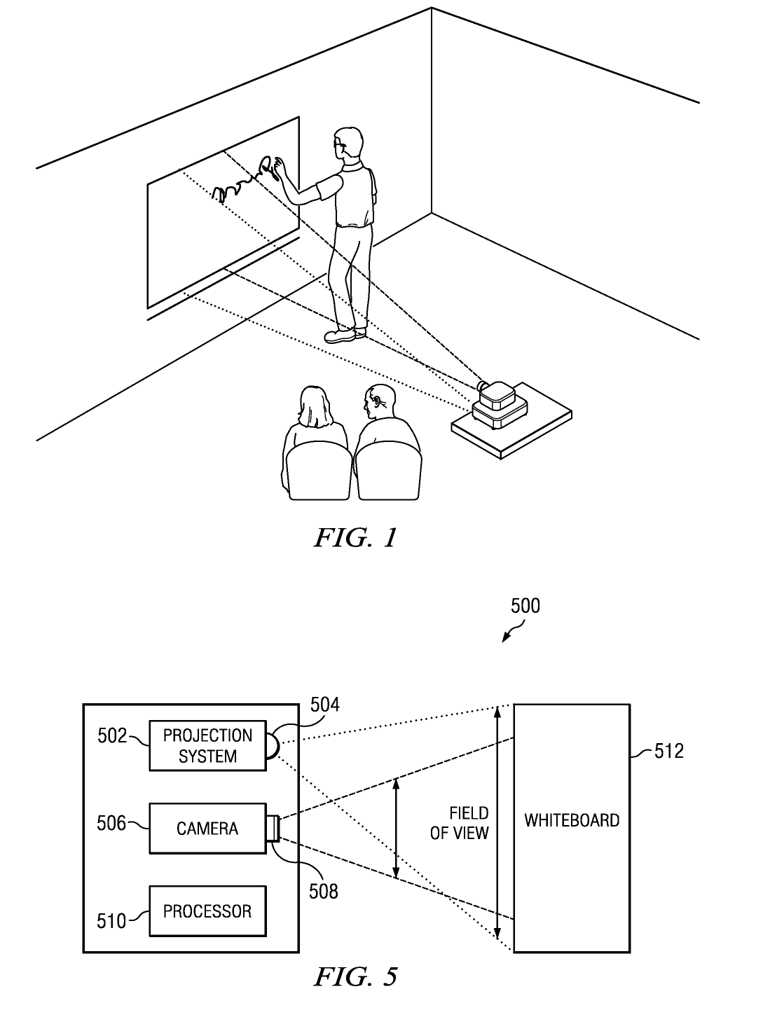

FIG. 1 is an embodiment of a white-board projector pair augmented with an image capturing device and a processor. As shown in FIG. 1, a typical white-board projector pair is augmented with an image capturing device and a processor. As a result, the imaging device can capture the content of a white-board, even when someone, such as, a teacher or presenter, is actively generating data on the white-board.

A processor analyzes the images captured by the image capturing device to model the content on the whiteboard. The processor adjusts the projected image as to enhance the whiteboard content. As a result, the experience is that of an enhanced white-board system on a white-board. The enhanced system extends the capability of the common ink-based markers via projection and image analysis technologies.

Using a marker with low ink can be frustrating at the whiteboard. In one embodiment, the enhanced white-board system can detect this condition and increase the contrast on the whiteboard by projecting an image that is tailored to the whiteboard's content. This solution would involve pixel-level analysis and decision about whether there is intended (real) ink on the board or not.

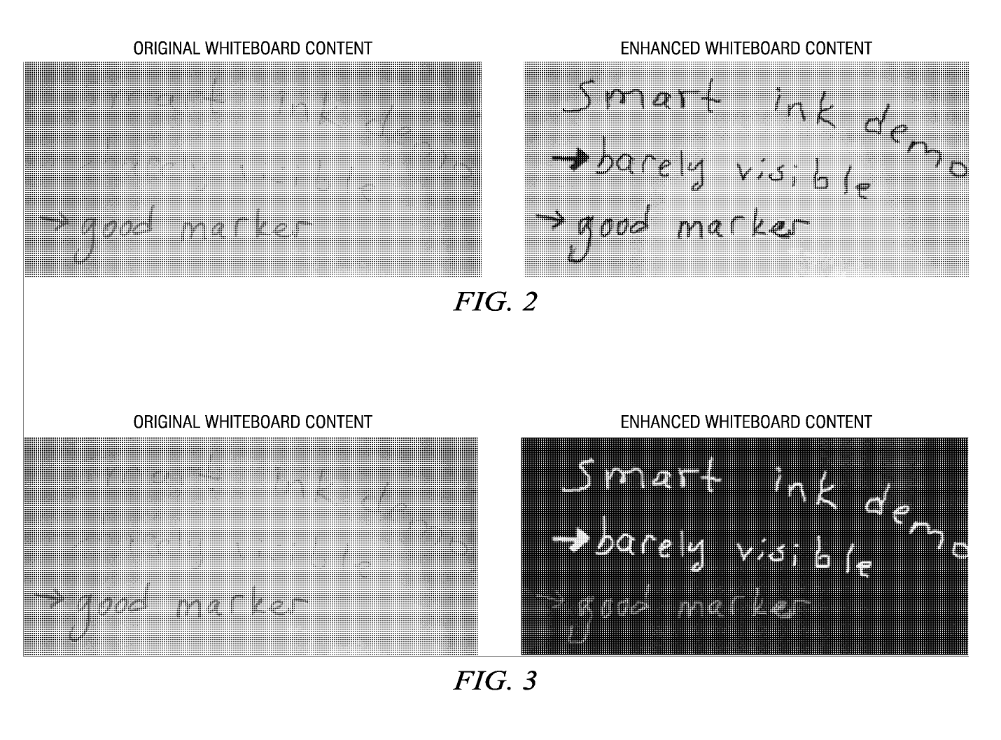

FIG. 2 is an embodiment of a demonstration of utilizing an enhanced white-board system in a low-ink and low-contrast whiteboard content. Shown in FIG. 2 are pictures of on a whiteboard with two kinds of writing on it: the top two rows are barely visible due to low ink, whereas utilize the enhanced white-board system the bottom row is a lot easier to read. FIG. 2 is an embodiment of a demonstration of utilizing enhanced white-board system in a low-ink and low-contrast whiteboard content by depositing extra “virtual ink” on those pixels of the screen that need it. The left image of FIG. 2 shows real-world images of this board with a projector displaying an empty page (all white) on it. On the right, the same whiteboard is shown utilizing the proposed enhanced white-board system.

In one embodiment, the enhanced white-board system projects an image with increased the contrast of the writing. FIG. 3 is an embodiment of a projector casting a dark image except on pixels where there is writing for increasing contrast. As shown in FIG. 3, the enhanced white-board system utilizes dramatic contrast enhancement via black-white inversion. On the right is the image of the same whiteboard where the projector is now casting a dark image except for selected pixels where there is writing.

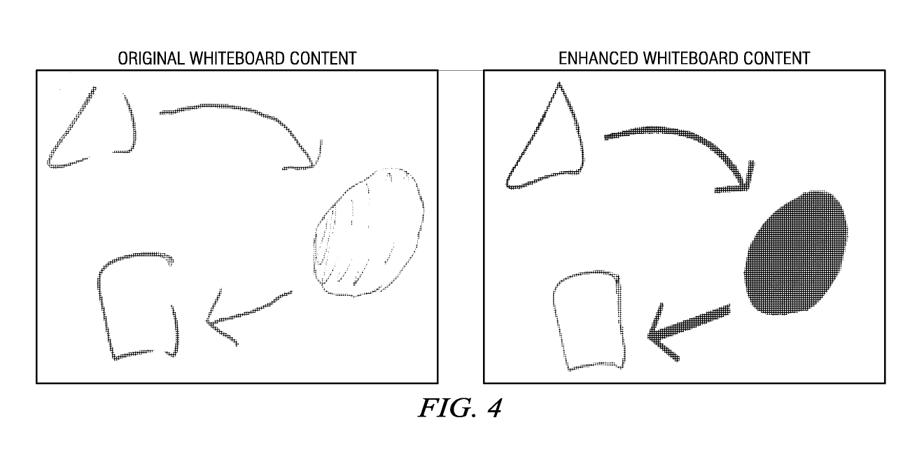

In one embodiment, shape completion, filling or thickening might be needed on a white-board. FIG. 4 is an embodiment of an enhanced white-board system utilized to complete drawings, fill within shapes, and color or thicken. In FIG. 4, the user is drawing on the whiteboard and completes them as needed. Note the missing corners and edges on the triangle and square on the left. The right image improves the display by the enhanced white-board system. Similarly, the arrows get thickened, and the scribble within the circle is interpreted as a request for automatic fill-in.

In one embodiment, a texture brush effects are needed on a white-board. The enhanced white-board system enables arbitrary brush shapes that would embellish a drawing. In other embodiments, animation and other motion effects are needed. Enhanced white-board system may also interpret the drawings and enhance them adaptively. For instance, an arrow point to the right could be superimposed with a texture that has left-to-right motion over time. Similarly, visual effects such as “marching ants” could help the presenter to guide the observer's attention.

In one embodiment, fast switching display device, i.e. DLP technology, maybe used. The enhanced white-board system leverages the following unique aspects of the fast switching display. A fast switching display device, such as DLP, may display a white flat-field image that is imperceptible by human observers. The enhanced white-board system leverages this snapshot to model the whiteboard under active DLP lighting. Similarly, during the short dark flat-field period that is imperceptible by human observers, the imaging sensor captures a scene in ambient light. The enhanced white-board system distinguishes between whiteboard pixels with and without ink on them and leverages the snapshot to model the whiteboard under ambient lighting.

In one embodiment, the enhanced white-board system does not require a specially engineered environment or to use special markers or pointers. The solution may be implemented and deployed within the projector box.

FIG. 5 is an embodiment of a block diagram of an enhanced white-board system 500. The enhanced white-board system 500 comprises a projection system 502, a camera 506, a processor 510, and a white-board 512. The projection system 502 includes a projection lens 504 that determines the field of view. The camera 506 comprises a camera lens 508 fro capturing the image of the board. The camera 506 may have more than one camera lens 508 that operate at the same time or at different times. The processor 510 communicates with the camera 506 and the projection system 502. The processor 510 is capable of performing the method for operating the enhanced white-board system and/or the method for calibrating the enhanced white-board system, which are described in more details below. The projection system 502, the camera 506 and the processor 510 may be encompassed in the same box/unit, may communicate via a wire or wirelessly. The projection lens 504 and the camera lens 508 are capable of retrieving and/or displaying to and from the white-board 512.

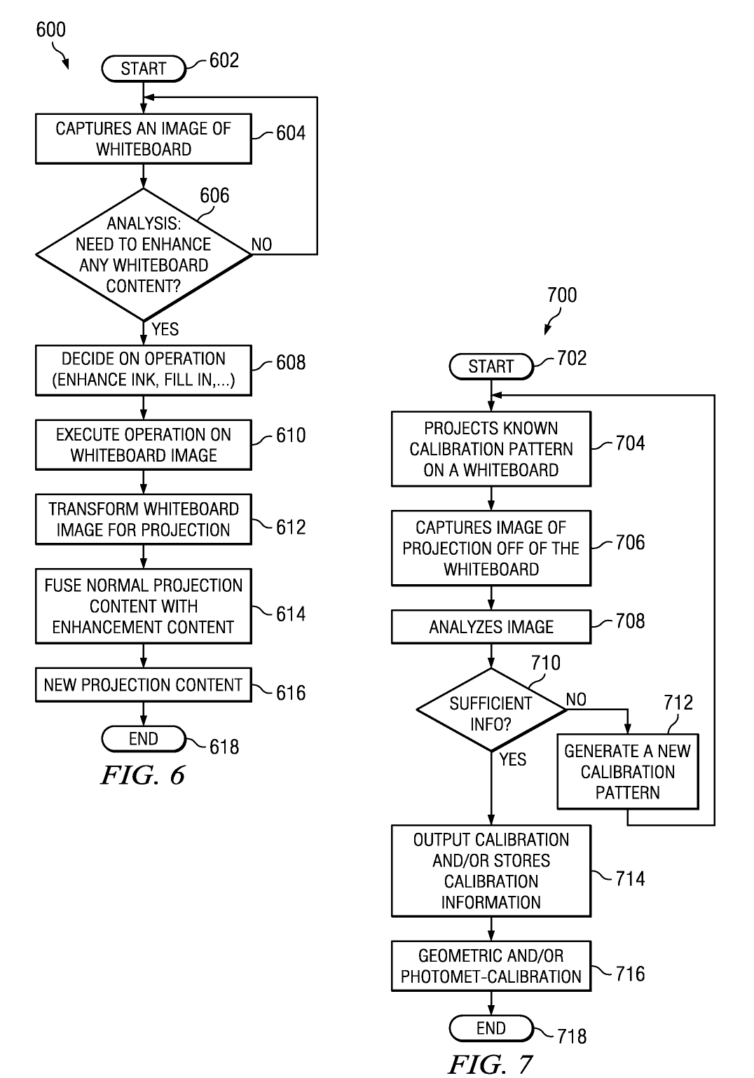

FIG. 6 is an embodiment of a flow diagram for a method 600 for operating an enhanced white-board system. The method 600 starts at step 602 and proceeds to step 604. At step 604, the method 600 captures an image off of a white-board. At step 606 the method 600 determined there is a need for enhancing the content on the white-board. If there is no need, the method 600 proceeds to 604; otherwise, the method 600 proceeds to step 608. At step 608, the method 600 decides on an operation, such as, enhance ink, fill ink, etc.

At step 610, the method 600 executes operation on white-board image. At step 612, the method 600 transforms the image to the white-board projection. At this step, the method 600 may perform geometric ad photometric calibration. At step 614, the method 600 fuses normal projection content with enhancement content. At step 616, the new projection content is displayed on the white-board. The method 600 ends at step 618.

FIG. 7 is an embodiment of a flow diagram method 700 for a method for calibrating an enhanced white-board system. The method 700 starts at step 702 and proceeds to step 704. At step 704, the method 700 projects known calibration pattern on a white-board utilizing a projection system. At step 706, the method 700 captures the image projection from the white-board. At step 708, the method 700 analyzes the image.

At step 710, the method 700 determines if the image analysis provided enough information. If the analysis did not provide enough information, the method 700 proceeds to step 712. At step 712, the method 700 generates a new calibration pattern and proceeds to step 704. Otherwise, the method 700 proceeds to step 714, wherein the method 700 outputs calibration and/or stores the information. At step 716, the method 700 performs geometric and/or photometric calibration. The method 700 ends at step 718. Such calibration may be performed online and/or off-line.

While the foregoing is directed to embodiments of the present invention, other and further embodiments of the invention may be devised without departing from the basic scope thereof, and the scope thereof is determined by the claims that follow.

What is claimed is:

1. An enhanced white-board system, comprising:
a camera captures an image relating to information on a white-board;
a processor retrieves and analyzes the captured image and enhances the projected information according to the analysis; and
a projection system projects the enhanced image on the white-board.

2. The enhanced white-board system of claim 1, wherein the camera is at least one of a single, stereo camera, and multiple cameras.

3. The enhanced white-board system of claim 1, wherein the processor performs calibration.

4. The enhanced white-board system of claim 3, wherein the processor performs at least one of geometric, photometric, online and offline calibration.

5. The enhanced white-board system of claim 1, wherein the camera captures two images, one image in ambient light and the other under projection system controlled illumination, and wherein the processor enhances the image based on analysis of the two images.

6. A method of an enhanced white-board system for projecting enhanced information, comprising:
capturing an image of information on a white-board;
analyzing the captured image and determining the type of enhancement needed for the information displayed;
enhancing the information in the image according to the determined type of enhancement; and
projecting the enhanced information on the white-board.

7. The method of claim 6 further comprising calibrating the projector.

8. The method of claim 7, wherein the calibrating step comprises:
projecting a known calibration pattern;
capturing an image of the projected calibration pattern;
analyzing the captured image; and
at least one of performing or archiving the calibration enhancement according to the analysis of the captured image.

9. The method of claim 8, wherein the performing calibration step comprising at least one of geometric, photometric, online and offline calibration.

10. The method of claim 6, wherein the capturing step captures two images, one image in ambient light and the other under controlled illumination, and wherein the enhancing step is based on analysis of the two images.

11. A non-transitory storage medium storing computer readable instructions, when executed perform a method for projecting enhanced information on a white-board, the method comprising:
capturing an image of information on a white-board;
analyzing the captured image and determining the type of enhancement needed for the information displayed;
enhancing the information in the image according to the determined type of enhancement; and
projecting the enhanced information on the white-board.

12. The non-transitory storage medium of claim 11 further comprising calibrating the projector.

13. The non-transitory storage medium of claim 12, wherein the calibrating step comprises:
projecting a known calibration pattern;
capturing an image of the projected calibration pattern;
analyzing the captured image; and
at least one of performing or archiving the calibration enhancement according to the analysis of the captured image.

14. The non-transitory storage medium of claim 13, wherein the performing calibration step comprising at least one of geometric, photometric, online and offline calibration.

15. The non-transitory storage medium of claim 11, wherein the capturing step captures two images, one image in ambient light and the other under controlled illumination, and wherein the enhancing step is based on analysis of the two images.
